(19) United States
(12) Patent Application Publication
(10) Pub. No.: US 2011/0204716 A1
(43) Pub. Date: Aug. 25, 2011

(54) OPERATION CONTROL SYSTEM

(75) Inventors: Taiji ABE, Nishio-city (JP); Yuji SUGIMOTO, Kariya-city (JP); Akira TAKAHASHI, Nisshin-city (JP)

(73) Assignees: NIPPON SOKEN, INC., Nishio-city (JP); DENSO CORPORATION, Kariya-city (JP)

(21) Appl. No.: 13/031,965

(22) Filed: Feb. 22, 2011

(30) Foreign Application Priority Data
Feb. 24, 2010 (JP) 2010-39122

(51) Int. Cl. B60L 1/14; B60L 1/00

(52) U.S. Cl. 307/10.8; 307/10.1

(57) ABSTRACT

In an operation control system, when a selection manipulation for blinking one of turn lamps is inputted using an in-vehicle combination switch, a frequency signal corresponding to the selection manipulation is outputted from a signal oscillation section to a signal transformation section via a common control line. In addition, the signal transformation section causes, out of two individual signal lines, an individual signal line corresponding to the inputted frequency signal to be in an active state. One of driver sections blinks one of turn lamps corresponding to the individual signal line being in the active state. It is noted that a drive control section stops temporarily operations of the turn lamps while both the input signal lines are in the active state.

### CROSS REFERENCE TO RELATED APPLICATION

The present application is based on and incorporates herein by reference Japanese Patent Application No. 2010-39122 filed on Feb. 24, 2010.

### FIELD OF THE INVENTION

The present invention relates to an operation control system which controls an operation state of an in-vehicle control target device, which operates intermittently.

### BACKGROUND OF THE INVENTION

[Patent document 1] JP-H9-267682A

Conventionally, there are combination switches near a steering wheel of a vehicle. One combination switch (lamp-use switch) integrates several switches for operating head lamps and each turn lamp; one combination switch (wiper-use switch) integrates several switches for operating a wiper or changing a working speed of the wiper.

Each switch integrated in the combination switch (lamp-use switch, or wiper-use switch) is connected with a switch module which executes a detection of an ON/OFF state. The switch module transmits a control signal indicating a result of the detection to each drive section such as a driver or a motor. Upon receiving the control signal, the drive section blinks a turn lamp at the time of left turn or right turn of the vehicle, or operates a wiper at a speed appropriate at the time of a rainfall.

For instance, Patent document 1 proposes an operation control system as an in-vehicle system as follows. With respect to each switch, a control signal (also referred to as a frequency signal) is predetermined to be used which has a unique frequency. When a switch module detects the ON state of several switches, frequency signals corresponding to the several switches are superimposed and transmitted to a control line. In between the control line and a drive section, a distributor is provided which distributes signals, which are serially inputted from the control line, to different routes depending on individual frequencies. Such a configuration simultaneously enables the concurrent transmission of several control signals and the reduction in the number of control lines.

It is noted that in a conventional operation control system, there is a case that a noise is superimposed on the frequency signal flowing through the control line, for example, during the blinking of the turn lamp arranged on the left side of a subject vehicle at the time of turning to the left. Such a case poses a possibility that the turn lamp arranged on the right side of the subject vehicle blinks depending on the frequency of the noise. Further, this case may cause a driver of a vehicle running behind the subject vehicle to hold a fear of insecurity (illusion) because of blinking of the turn lamps of both the sides of the subject vehicle that was expected to turn to the left.

In addition, in a conventional operation control system, for example, there is a case that while a wiper operates at a low speed, a noise having a frequency corresponding to a control signal to operate the wiper at a high speed is superimposed on the control line. In such a case, it is supposed that several control signals are simultaneously inputted with respect to one control target device. It is thus necessary to execute a process to determine which input signal should be adopted (arbitration), thereby posing a possibility to make the control complicated.

### SUMMARY OF THE INVENTION

The present invention is made to solve the above problem. It is an object of the present invention to provide a technology to reduce an influence of a noise on a control target device, using a simple configuration, in an operation control system which controls an operating state of the control target device that operates intermittently.

To achieve the above object, according to an example of the present invention, an operation control system, which controls operation states of a control target device that operates intermittently, is provided as follows. A manipulation input section is included to input a selection manipulation that selects one operation state out of a plurality of operation states of the control target device operating intermittently, the plurality of operation states being mutually exclusive towards one another. A signal output section is included to output, out of a plurality of control frequencies, a control frequency, which corresponds to the selection manipulation inputted by the manipulation input section, to a common control line. The plurality of control frequencies are predetermined to have mutually different frequencies assigned respectively to the plurality of operation states. A signal transformation section is included to cause, out of a plurality of individual signal lines, an individual signal line, which corresponds to the control frequency inputted from the common control line, to become in an active state. The plurality of individual signal lines respectively correspond to the plurality of control frequencies. A drive section is included to connect with the plurality of individual signal lines, and drive the control target device so as to become in an operation state corresponding to the individual signal line that is in an active state, out of the plurality of operation states. A drive control section is included to be in between the signal transformation section and the drive section so as to prohibit the drive section from driving the control target device for a duration while at least two individual signal lines out of the plurality of individual signal lines are in the active state.

That is, in the above operation control system, while the control target device operates or works intermittently under a certain operation state, there may be a case where a noise, which is equivalent to a control frequency or frequency signal for operating the control target device under another operation state, superimposes on the control line. In such a case, the operation or working of the control target device is interrupted temporarily by the drive control section. When the noise then disappears, the operation of the control target device is resumed under the previous operation state.

Therefore, according to the operation control system, if the superimposing time of the noise on the control line has a duration smaller than the intermittent duration in the operation of the control target device, the influence of the noise given to the control target device can be disregarded. Thus, the above configuration of the operation control system which controls an operating state of the control target device operating intermittently can reduce an influence of a noise upon the control target device, using a simple configuration.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram illustrating a schematic configuration of a vehicle that is provided with an operation control system according to an embodiment of the present invention;

FIG. 2 is a block diagram illustrating a configuration of a motor section;

FIG. 3 is a diagram illustrating a configuration of a signal oscillation section;

FIG. 4 is a diagram illustrating a configuration of a signal transformation section and a front drive control section; and

FIG. 5 is a diagram illustrating a modification example of a lamp-use logic circuits.

### DETAILED DESCRIPTION OF THE PREFERRED EMBODIMENTS

Hereafter, description will be given to embodiments of the present invention with reference to drawings.

<Overall Configuration>

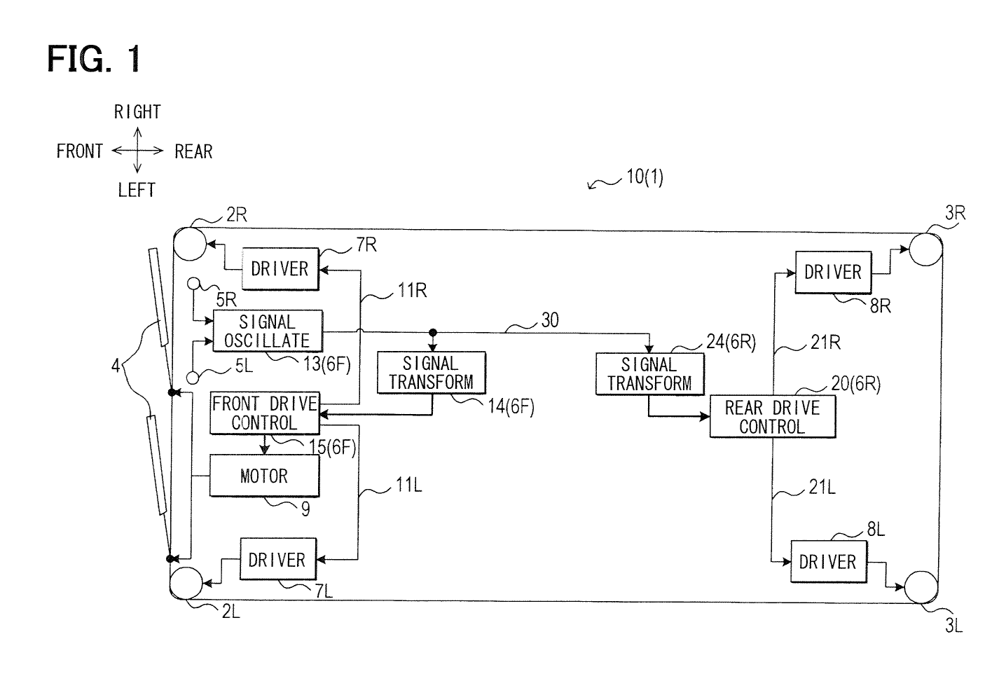

FIG. 1 is a diagram illustrating a schematic configuration of a vehicle 1 that is provided with an operation control system according to an embodiment of the present invention.

As illustrated in FIG. 1, an operation control system 10 controls operating states of the following: a pair of turn lamps 2L, 2R arranged at front portions symmetrically in a left-right direction of the vehicle 1, respectively; a pair of turn lamps 3L, 3R arranged at rear portions symmetrically in a left-right direction of the vehicle 1, respectively; and a front wiper 4 arranged on a windshield of the vehicle 1.

For instance, the operation control system 10 includes the following: two combination switches 5L, 5R protruding to a left and right directions from a rear side of a steering wheel of the vehicle 1, respectively; two junction blocks 6F, 6R as distributing boxes provided near a driver seat and a rear seat of the vehicle 1, respectively; four driver sections 7L, 7R, 8L, 8R arranged near turn lamps 2L, 2R, 3L, 3R, respectively; and a motor section 9 arranged near a front wiper 4.

[Configuration of Combination Switches]

The combination switches 5L, 5R are a combination switch 5L (also referred to as a wiper-use switch) used to operate a wiper device such as the front wiper 4, and a combination switch 5R (also referred to as a lamp-use switch) used to operate a lamp device such as turn lamps 2, 3.

The wiper-use switch 5L is a well-known switch to include in an integrated manner, the following: a HIGH operation switch to set the front wiper 4 at a HIGH operation mode where a working speed is a high speed; a LOW operation switch to set the front wiper 4 at a LOW operation mode where a working speed is a low speed; an INTERMITTENT operation switch to set the front wiper 4 at an INTERMITTENT operation mode where an intermittent duration in working is comparatively long; a rear switch to operate a rear wiper (not shown); and a windshield washer switch to jet out a window washer liquid.

Further, for instance, the working speed of the front wiper 4 in the INTERMITTENT operation mode is designated at the same working speed as that in the LOW operation mode. In addition, the HIGH operation mode, the LOW operation mode, and the INTERMITTENT operation mode are operation states having mutually exclusive relationship in the front wiper 4. In other words, only one of the HIGH operation mode, the LOW operation mode, and the INTERMITTENT operation mode is allowed to operate at a time. In the following, the explanation is made in paying attention to the HIGH operation switch, the LOW operation switch, and the INTERMITTENT operation switch among the wiper-use switches 5L.

The lamp-use switch 5R is a well-known switch to include in an integrated manner the following: a left turn switch to blink the left turn lamps 2L, 3L arranged on the left-hand side of the vehicle 1; a right turn switch to blink the right turn lamps 2R, 3R arranged on the right-hand side of the vehicle 1; a small switch to turn on a small lamp and a taillight; a head switch to turn on a head lamp (low beam); and a high beam switch to turn on a high beam.

Further, the blinking of the left turn lamps 2L, 3L and the blinking of the right turn lamps 2R, 3R are operation states having mutually exclusive relationship relative to the turn lamps 2, 3. In the following, the explanation is made in paying attention to the left turn switch and the right turn switch among the lamp-use switch 5R. In addition, there is generally provided a hazard switch to blink simultaneously the left turn lamps 2L, 3L and the right turn lamps 2R, 3R in the instrument panel of the vehicle 1. The hazard switch is not main in the present embodiment; the explanation is omitted.

[Configuration of Driver Section]

Next, the driver sections 7L, 7R, 8L, 8R include the following: a left front driver section 7L to drive the left front turn lamp 2L arranged at a left portion in the front of the vehicle 1; a right front driver section 7R to drive the right front turn lamp 2R arranged at a right portion in the front of the vehicle 1; a left rear driver section 8L to drive the left rear turn lamp 3L arranged at a left portion in the rear of the vehicle 1; and a right rear driver section 8R to drive the right rear turn lamp 3R arranged at a right portion in the rear of the vehicle 1.

The driver sections 7L, 7R, 8L, 8R are arranged on electric power supply lines from an in-vehicle battery to the turn lamps 2L, 2R, 3L, 3R, respectively (not shown). The driver sections 7L, 7R, 8L, 8R include NPN transistors, in each of which a collector is connected to one terminal of each turn lamp 2L, 2R, 3L, 3R while an emitter is connected to a minus terminal electric potential (ground potential) of the in-vehicle battery. The other terminal of each turn lamp 2L, 2R, 3L, 3R is connected to a plus terminal electric potential (battery potential) of the in-vehicle battery.

In addition, each front driver section 7L, 7R is connected to each output signal line 11L, 11R that derives from the front drive control section 15. In addition, each rear driver section 8L, 8R is connected to each output signal line 21L, 21R that derives from the rear drive control section 20.

When each output signal line 11L, 11R, 21L, and 21R is in the active state, each driver section 7L, 7R, 8L, 8R causes own transistor to turn ON/OFF in a cycle (referred to as a turn cycle) in which the turn lamps 2, 3 are blinked; thereby each turn lamp 2L, 2R, 3L, 3R is driven.

That is, the left driver sections 7L, 8L blink the left turn lamps 2L, 3L when the output signal lines 11L, 21L are in the active state, respectively. In contrast, the right driver sections 7R, 8R blink the right turn lamps 2R, 3R when the output signal lines 11R, 21R are in the active state, respectively.

[Configuration of Motor Section]

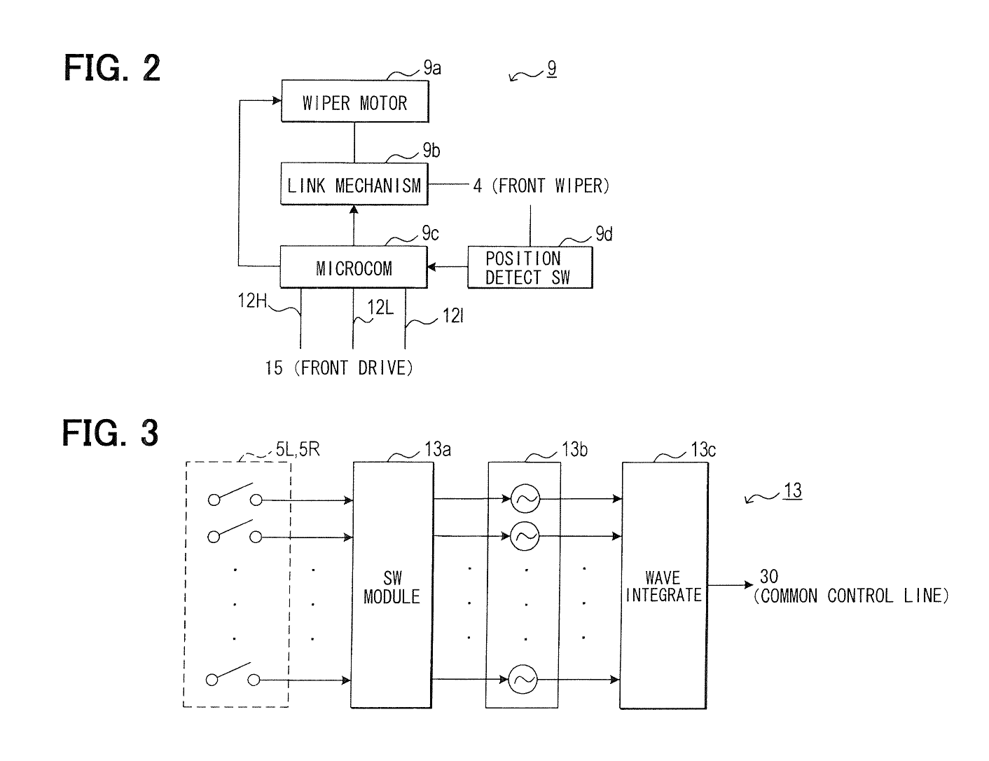

With reference to FIG. 2, the motor section 9 includes the following: a wiper motor 9a to rotate in response to a feeding power from the in-vehicle battery; a link mechanism 9b to transmit a rotational driving force of the wiper motor 9a to the front wiper 4; and a microcomputer 9c connected to three output signal lines 12H, 12L, 121 which derive from the front drive control section 15.

Further, the microcomputer 9c drives the front wiper 4 by controlling the wiper motor 9a and the link mechanism 9b so as to become in the operation mode corresponding to an output signal line, which is in the active state, among the output signal lines 12H, 12L, 121. In the present embodiment, the rotation speed of the wiper motor 9a is adjusted by a well-known PWM control which changes a powering state from the in-vehicle battery to the wiper motor 9a. In addition, although the rotation direction of the output axis of the wiper motor 9a is constant, the front wiper 4 is designed to work reciprocally by the link mechanism 9b.

Furthermore, the microcomputer 9c is connected with a position detection switch 9d to detect that the front wiper 4 arrives at a lower end position. When all the output signal lines 12H, 12L, and 121 are in the inactive state, the microcomputer 9c executes a control such that the front wiper 4 stops at the lower end position via the wiper motor 9a and the link mechanism 9b. Herein, a reciprocally working on the windshield of the front wiper 4 starting from the lower end position and then returning to the lower end position is defined as one trip on the windshield of the front wiper 4. In this context, the operating modes of the HIGH operation mode, the LOW operation mode, and the INTERMITTENT operation mode may be referred to a highest repetition trip mode, an intermediate repetition trip mode, and a lowest repetition trip mode.

[Configuration of Junction Block]

Again, with reference to FIG. 1, junction blocks (J/B) 6F, 6R are a front JIB 6F arranged near the driver seat of the vehicle 1, and a rear J/B 6R arranged near the rear seat of the vehicle 1.

Further, the rear J/B 6R includes a signal transformation section 24 and a rear drive control section 20. The signal transformation section 24 has a configuration similar to that of the signal transformation section 14 of the front J/B 6F; the rear drive control section 20 has a configuration similar to that of the lamp-use logic circuits 18a, 18b of the front drive control section 15. Thus, the explanation is omitted.

In contrast, the front J/B 6F includes the following: a signal oscillation section 13 which detects a switch manipulation to the combination switches 5L, 5R by the driver of the vehicle 1, and oscillate a control signal having a frequency corresponding to the switch manipulation; a signal transformation section 14 which distributes a signal flowing through the common control line 30 connected to the signal oscillation section 13, with respect to each of frequencies; and the front drive control section 15 arranged in between (i) the signal transformation section 14 and (ii) the front driver section 7L, 7R, or the motor section 9.

The signal oscillation section 13, as illustrated in FIG. 3, includes the following: several switch modules 13a which detect ON/OFF state of each of switches integrated into the combination switches 5L, 5R; several local oscillators 13b which are connected to the switch module 13 for oscillating control signals (frequency signals) having mutually different frequencies; and a wave integration section 13c which superimposes frequency signals, which are oscillated from the local oscillators 13b, on the common control line 30 to output.

It is noted that the frequency signals are previously prepared so as to have frequencies different from each other depending on operation states of the turn lamps 2, 3 and the front wiper 4, respectively. When a detection signal (switch signal) which indicates the ON state of a certain switch is inputted from the switch module 13a connected to the local oscillator 13b, each local oscillator 13b oscillates a frequency signal corresponding to the switch signal (i.e., corresponding to the switch manipulation by the driver).

For example, suppose a case that a lamp SW signal and a wiper switch signal are inputted. The lamp SW signal is a switch signal for blinking one of (i) the left turn lamps 2L, 3L and (ii) the right turn lamps 2R, 3R; the wiper SW signal is a switch signal for operating the front wiper 4 under one of the operation modes among the HIGH operation mode, the LOW operation mode, and the INTERMITTENT operation mode. In such a case, a frequency signal corresponding to the lamp SW signal and a frequency signal corresponding to the wiper SW signal are outputted from the local oscillator 13b to the wave integration section 13c. Further, the wave integration section 13c outputs two frequency signals by superimposing them on the common control line 30.

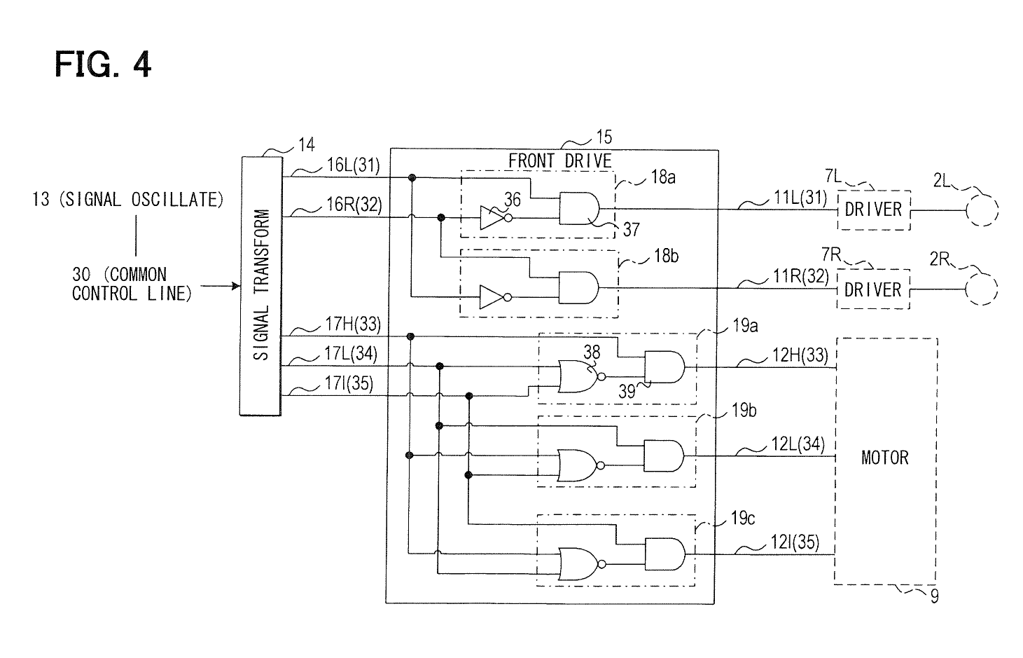

Each of the frequencies previously assigned individually to the turn lamps 2, 3 and the operation states of the front wiper 4 is referred to as a control frequency. With reference to FIG. 4, the signal transformation section 14 distributes a signal, which is inputted from the common control line 30 connected to the signal oscillation section 13, into five individual signal lines 31 to 35 corresponding to individual control frequencies, thereby causing the individual signal line, which the signal is inputted into (referred to as an input signal line) among the five individual signal lines 31 to 35, to become in the active state.

The individual signal lines 31 to 35 include the following: a first individual signal line 31 arranged in between the signal transformation section 14 and the left front driver section 7L which drives the left front turn lamp 2L; a second individual signal line 32 arranged in between the signal transformation section 14 and the right front driver section 7R which drives the right front turn lamp 2R; a third individual signal line 33 arranged in between the signal transformation section 14 and the motor section 9 in correspondence to the HIGH operation mode in the front wiper 4; a fourth individual signal line 34 arranged in between the signal transformation section 14 and the motor section 9 in correspondence to the LOW operation mode in the front wiper 4; and a fifth individual signal line 35 arranged in between the signal transformation section 14 and the motor section 9 in correspondence to the INTERMITTENT operation mode in the front wiper 4.

Furthermore, the first individual signal line 31 contains a first input signal line 16L arranged in between the signal transformation section 14 and the front drive control section 15, and a first output signal line 11L arranged in between the front drive control section 15 and the left front driver section 7L. The second individual signal line 32 contains a second input signal line 16R arranged in between the signal transformation section 14 and the front drive control section 15, and a second output signal line 11R arranged in between the front drive control section 15 and the right front driver section 7R. Furthermore, the third to fifth individual signal lines 33 to 35 contain third to fifth input signal lines 17H, 17L, 17I arranged in between the signal transformation section 14 and the front drive control section 15, and third to fifth output signal lines 12H, 12L, 12I arranged in between the front drive control section 15 and the motor section 9, respectively.

[Configuration of Front Drive Control Section]

The front drive control section 15 includes the following: two logic circuits (referred to as lamp-use logic circuits) 18a, 18b, which are arranged in between the signal transformation section 14 and the front driver sections 7L, 7R, respectively; and three logic circuits (referred to as wiper-use logic circuits) 19a, 19b, 19c in between the signal transformation section 14 and the motor section 9, in correspondence to three different operation modes, respectively.

To expedite the following explanation, with respect to the individual signal lines 31 to 35, the active state is represented by “1,” while the inactive state is represented by “0.” The lamp-use logic circuits 18a, 18b include the following: a logic circuit 18a for executing an operation control of the left front lamp 2L; and a logic circuit 18b for executing an operation control of the right front lamp 2R. The operation control is to start or stop the operation of each turn lamp.

Among those, the left lamp-use logic circuit 18a includes an inverter 36 and an AND circuit 37. The inverter 36 reverses the state of the second input signal line 16R (i.e., “1”->“0,” or “0”->“1”). The AND circuit 37 sets the first output signal line 11L at “1” in the case that both the outputs from the first input signal line 16L and the inverter 36 are “1” (i.e., “1, 1”); in contrast, the AND circuit 37 sets the first output signal line 11L at “0” in the case of the others (i.e., “1, 0”, “0, 1”, “0, 0”).

That is, the left front lamp-use logic circuit 18a causes the first output signal line 11L to become in the active state only in the case that the first input signal line 16L is in the active state and, simultaneously, the second input signal line 16R is in the inactive state. When the first output signal line 11L becomes in the active state, the left front turn lamp 2L is blinked by the left front driver section 7L.

Further, similarly, the right front lamp-use logic circuit 18b causes the second output signal line 11R to become in the active state only in the case that the second input signal line 16R is in the active state and, simultaneously, the first input signal line 16L is in the inactive state. Further, when the second output signal line 11R becomes in the active state, the right front turn lamp 2R is blinked by the right front driver section 7R.

The wiper-use logic circuits 19a, 19b, 19c include a HIGH wiper-use logic circuit 19a, a LOW wiper-use logic circuit 19b, and an INTERMITTENT wiper-use logic circuit 19c. The HIGH wiper-use logic circuit 19a executes an operation control of the front wiper 4 in the HIGH operation mode. The LOW wiper-use logic circuit 19b executes an operation control in the LOW operation mode. The INTERMITTENT wiper-use logic circuit 19c executes an operation control in the INTERMITTENT operation mode. The operation control is to start and stop an operation of the front wiper 4 in each operation mode or state.

Among those, the HIGH wiper-use logic circuit 19a includes a NOR circuit 38, and an AND circuit 39. The NOR circuit 38 outputs “1” only in the case that both the outputs of the fourth input signal line 17L and the fifth input signal line 17I are “0” (i.e., “0, 0”->“1”, “1, 0”->“0”, “0, 1”->“0”, and “1, 1”->“0”). The AND circuit 39 sets the third output signal line 12H at “1” in the case that both the outputs from the third input signal line 17H and the NOR circuit 38 are “1” (i.e., “1, 1”); the AND circuit 39 sets the third output signal line 12H at “0” in the case of others (i.e., “1, 0”, “0, 1”, “0, 0”).

That is, the HIGH wiper-use logic circuit 19a causes the third output signal line 12H to become in the active state only in the case that the third input signal line 17H is in the active state and, simultaneously, the fourth and fifth input signal lines 17L, 17I are in the inactive state. The front wiper 4 is operated by the motor section 9 in the HIGH operation mode when the third output signal line 12H is in the active state.

Similarly, the LOW wiper-use logic circuit 19b operates the front wiper 4 in the LOW operation mode when the fourth output signal line 12L is in the active state. Further, similarly, the INTERMITTENT wiper-use logic circuit 19c operates the front wiper 4 in the INTERMITTENT operation mode when the fifth output signal line 12I is in the active state.

[Example of Operation]

Thus configured operation control system 10 is provided as follows. For instance, when the left turn switch in the lamp-use switch 5R is turned into the ON state, a control signal of a frequency f1 corresponding to the left turn lamps 2L, 3L is outputted to the signal transformation section 14 via the common control line 30 from the signal oscillation section 13.

The input signal line 16L (first individual signal line 31) corresponding to the control signal of the frequency f1 is set to “1” by the signal transformation section 14. The first output signal line 11L (first individual signal line 31) is set to “1” by the left front lamp-use logic circuit 18a. Thereby, the left front turn lamp 2L is blinked by the left front driver section 7L. Further, although detailed explanation is omitted, at the time of operating the left front turn lamp 2L, the left rear turn lamp 3L is operated similarly by the left rear driver section 8L.

When a noise having the frequency f2 corresponding to the right turn lamps 2R, 3R is superimposed on the common control line 30 at the time of blinking the left front turn lamp 2L, the signal transformation section 14 sets the second input signal line 16R as well as the first output signal line 11L to “1” (i.e., the output from the inverter 36 is set to “0”). The first output signal line 11L (first individual signal line 31) is thus set to “0” by the AND circuit 37. Thereby, the left front turn lamp 2L is turned off temporarily by the left front driver section 7L. In addition, by the right front lamp-use logic circuit 18b, the second output signal line 11R (second individual signal line 32) is also set to “0” by the right front lamp-use logic circuit 18b. The right front turn lamp 2R thus continues to be turned in the OFF state (i.e., continues to be turned off).

When the noise of the frequency f2 disappears, the first input signal line 16L (first individual signal line 31) continues to be “1”, and the second input signal line 16R is set to “0” (i.e., the output from the inverter 36 is set to “1”). The first output signal line 11L (first individual signal line 31) is set to “1” by the AND circuit 37. Thereby, the blinking of the left front turn lamp 2L is re-started by the left front driver section 7L. The second output signal line 11R (second individual signal line 32) continues to be “0” by the right front lamp-use logic circuit 18b. The right front turn lamp 2R thus continues to be turned in the OFF state.

That is, there may be a case that when the left turn lamps 2L, 3L blink, a noise equivalent to the frequency signal for blinking the right turn lamps 2R, 3R is superimposed on the common control line 30. In such a case, the operation of the turn lamps 2, 3 is stopped (i.e., turned off) temporarily by the drive control sections 15, 20. When the noise disappears, the blinking of the left turn lamps 2L, 3L is resumed.

Further, there may be a case that when the right turn lamps 2R, 3R blink, a noise equivalent to the frequency signal for blinking the left turn lamps 2L, 3L is superimposed on the common control line 30. In such a case, an analogous operation takes place. In addition, there may be a case that when the front wiper 4 operates in one operation mode, a noise equivalent to a frequency signal for another operation mode is superimposed on the common control line 30. In such a case, an analogous operation takes place, similarly.

Finally, in the above embodiment, the lamp-use switch 5R or the wiper-use switch 5L may be referred to as a manipulation input section; the signal oscillation section 13 may be referred to as a signal output section; the driver sections 7, 8 or the motor device 9 may be referred to as a drive section.

[Modification]

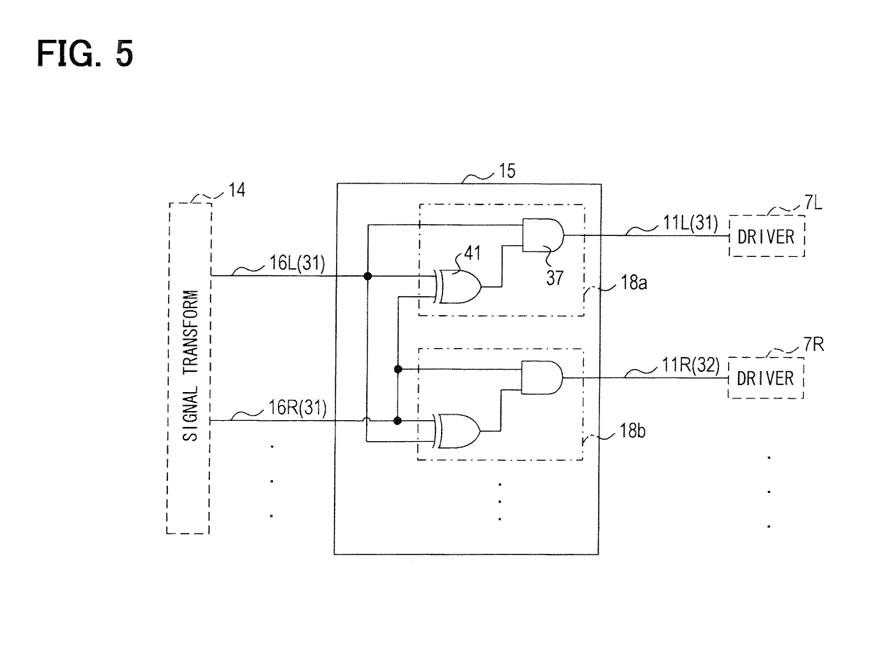

Although each of the lamp-use logic circuits 18a, 18b includes an inverter 36 and an AND circuit 37 in the above embodiment, the inverter 36 may be replaced by an XOR circuit 41, as illustrated in FIG. 5.

For instance, in the left front lamp-use logic circuit 18a, only in the case that the output of one of the first input signal line 16L and the second input signal line 16R is “1”, “1” is outputted by the XOR circuit 41 (That is, “0, 0”->“0”, “1, 0”->“1”, “0, 1”->“1”, and “1, 1”->“0”). When both the outputs from the first input signal line 16L and the XOR circuit 41 are “1”, the first output signal line 11L is set to “1” by the AND circuit 39.

That is, similarly, the left front lamp-use logic circuit 18a having such a configuration may be provided as follows. Only in the case that the first input signal line 16L is in the active state and, simultaneously, the second input signal line 16R is in the inactive state, the first output signal line 11L is caused to become in the active state. Further, although detailed explanation is omitted, the right front lamp-use logic circuit 18b may be provided similarly.

[Effect of Present Embodiment]

As explained above, in the operation control system of the present embodiment, at the time of blinking one of the left turn lamp 2 and the right turn lamp 3 or at the time of operating the front wiper 4 under one of operation modes, there may be superimposed a noise equivalent to the frequency signal for blinking the other turn lamp, or a noise equivalent to the frequency signal for operating the front wiper 4 under another operation mode, on the common control line 30. Even in such a case, the influence of the noise can be relieved.

That is, in the operation control system 10, even when the above noise is superimposed on the common control line 30, one of the several logic circuits included in the drive control sections 15 interrupts temporarily an operation of a control target device or section which is operated intermittently such as turn lamps 2, 3 or front wiper 4. When the noise disappears, the operation of the control target device is resumed under the previous operation state.

There may be an instant noise which appears and superimposes on the common control line 30 for a short duration shorter than an intermittent duration in the operation of the control target device 2 to 4. Against such a noise, according to the operation control system 10, an influence of the noise given to the control target device 2 to 4 can be disregarded by using the simple hardware configuration, without executing complicated control.

In addition, such a configuration can help prevent both of the turn lamps 2, 3 from unintentionally blinking simultaneously at the time of turning to the left or right of the vehicle 1. Even if the noise occurs for a duration longer than a duration for which the turn lamp 2, 3 is turned off, the blinking of the turn lamp 2, 3 may be temporarily extended only a little while the influence of the noise given to the turn lamp 2, 3 can be relieved as a result.

Furthermore, the above configuration can help prevent the front wiper operating at a slow speed from unintentionally operating at a high speed during the vehicle traveling to cause the driver to be surprised. Even if the noise occurs for a duration longer than an intermittent duration of the front wiper 4, the original speed of the wiper may be only reduced temporarily. The influence of the noise given to the wiper 4 can be relieved as a result.

Further, in the operation control system 10, even if the noise occurs during the operation of the front wiper 4 to cause the output signal lines 12H, 12L, 121 to become in the inactive state, the front wiper 4 is moved once to the lower end position by the motor section 9. When the noise disappears during the operation period, the front wiper 4 starts the operation under the original operation mode. The influence of the noise given to the wiper 4 can be disregarded as a result.

### Other Embodiments

Up to this point, description has been given to an embodiment of the present invention. However, the present invention is not limited to the above embodiment, and it can be variously embodied as long as not departing from the subject matter of the present invention.

In the above embodiment, the signal oscillation section 13 is provided with several local oscillators 13b which oscillate several control signals (frequency signals) having mutually different frequencies. Without need to be limited to the above, another may be adopted. For example, there may be provided several filters which pass signals having mutually different frequencies.

Further, in the above embodiment, the signal transformation section 14, 24 distributes the signal inputted from the common control line 30 into the individual signal lines depending on respective control frequencies, thereby setting the individual signal line, to which the signal is inputted, to the active state. There is no need to be limited thereto. For instance, based on the control frequency of the signal inputted from the common control line 30, a signal representing binary values may be outputted to each individual signal line such that the inactive state is represented by “0” while the active state is represented by “1.”

Further, in the operation control system 10 of the above embodiment, the turn lamp 2, 3 or the front wiper 4 of the vehicle 1 is exemplified as a control target device. Without need to be limited thereto, the present system 10 may be applied to a system including as a control target device a device or section which operates intermittently.

Aspects of the disclosure described herein are set out in the following clauses.

As an aspect of the disclosure, an operation control system, which controls operation states of a control target device that operates intermittently, is provided as follows. A manipulation input section is included to input a selection manipulation that selects one operation state out of a plurality of operation states of the control target device operating intermittently, the plurality of operation states being mutually exclusive towards one another. A signal output section is included to output, out of a plurality of control frequencies, a control frequency, which corresponds to the selection manipulation inputted by the manipulation input section, to a common control line. The plurality of control frequencies are predetermined to have mutually different frequencies assigned respectively to the plurality of operation states. A signal transformation section is included to cause, out of a plurality of individual signal lines, an individual signal line, which corresponds to the control frequency inputted from the common control line, to become in an active state. The plurality of individual signal lines respectively correspond to the plurality of control frequencies. A drive section is included to connect with the plurality of individual signal lines, and drive the control target device so as to become in an operation state corresponding to the individual signal line that is in an active state, out of the plurality of operation states. A drive control section is included to be in between the signal transformation section and the drive section so as to prohibit the drive section from driving the control target device for a duration while at least two individual signal lines out of the plurality of individual signal lines are in the active state.

As an optional aspect of the disclosure, the above operation control system may be further provided as follows. Each of the individual signal lines includes an input signal line arranged in between the signal transformation section and the drive control section, and an output signal line arranged in between the drive control section and the drive section. The drive control section is connected with the signal transformation section via a plurality of input signal lines, the drive control section including a plurality of logic circuits connected to the drive section via a plurality of output signal lines, respectively. Out of the plurality of output signal lines, an output signal line connected with one of the plurality of logic circuits is defined as a target output signal line relative to the one of the plurality of logic circuits. Out of the plurality of input signal lines, an input signal constituting one of the individual signal line along with the target output signal line is defined as a target input signal line relative to the one of the plurality of logic circuits while any other input signal line of the plurality of input signal lines excluding the target input signal is defined as a non-target input signal line relative to the one of the plurality of logic circuits. The drive control section causes the target output signal line to become in the active state only when the target input signal line is in the active state and, simultaneously, the non-target input signal line is in an inactive state.

In the above configuration, without need to execute a process using a software program, the operation of the control target device can be stopped and resumed according to the status of the individual signal line; by using a simple configuration of a hardware device (logic circuit), the influence of the noise given to the control target device can be relieved.

As an optional aspect of the disclosure, in the above operation control system, the control target device may be a wiper provided in a vehicle; and the plurality of operating states may include a plurality of operation speeds of the wiper.

Here, the operation speed includes a speed that varies depending on the intermittent duration in the working or operation of the wiper, respectively. Further, in other words, several operation states of the wiper may be defined as variations in repetition times of trips on the windshield of a vehicle.

For instance, when the wiper operates at a certain operation speed or cycle at which the wiper is repeatedly stopped and driven, there may be a case that a noise arises that causes the wiper to operate at a different speed or cycle. Even in such a case, after the drive of the wiper stops temporarily, the drive of the wiper is resumed at the speed or cycle operated prior to the stopping.

Thus, for instance, the above configuration can help prevent the front wiper operating at a slow speed from unintentionally starting to operate at a high speed during the vehicle traveling, thereby surprising the driver. Further, even if the noise occurs for a duration longer than an intermittent duration of the front wiper, the original speed or repetition times of trips per unit time of the wiper may be only reduced temporarily. The influence of the noise given to the wiper can be relieved as a result.

As an optional aspect of the disclosure, in the above operation control system, the control target device may be a pair of a left turn lamp and a right turn lamp that are arranged symmetrically in a left-right direction in a vehicle. The plurality of operation states may include (i) a state where one of the left turn lamp and the right turn lamp is blinked and (ii) a state where an other of the left turn lamp and the right turn lamp is blinked.

When one side turn lamp repeats turning-on and turning-off to thereby blink, there may be a case that a noise arises which causes the other side turn lamp to blink. Even in such a case, after the turn lamps of both the sides turn off temporarily, the turn lamp that was blinking prior to the turning-off re-starts the turning-on.

Thus, this can help prevent the turn lamps of both the sides (i.e., left and right) from simultaneously blinking unintentionally. Further, even if a noise occurs for a duration longer than a duration for which the turn lamp is turned off, the blinking of the turn lamp may be temporarily extended only a little while. The influence of the noise given to the turn lamp can be thereby relieved as a result.

It will be obvious to those skilled in the art that various changes may be made in the above-described embodiments of the present invention. However, the scope of the present invention should be determined by the following claims.

What is claimed:

1. An operation control system to control operation states of a control target device that operates intermittently, the system comprising:
a manipulation input section to input a selection manipulation that selects one operation state out of a plurality of operation states of the control target device operating intermittently, the plurality of operation states being mutually exclusive towards one another;
a signal output section to output, out of a plurality of control frequencies, a control frequency, which corresponds to the selection manipulation inputted by the manipulation input section, to a common control line,
the plurality of control frequencies being predetermined to have mutually different frequencies assigned respectively to the plurality of operation states;
a signal transformation section to cause, out of a plurality of individual signal lines, an individual signal line, which corresponds to the control frequency inputted from the common control line, to become in an active state,
the plurality of individual signal lines respectively corresponding to the plurality of control frequencies;
a drive section to
connect with the plurality of individual signal lines, and
drive the control target device so as to become in an operation state corresponding to the individual signal line that is in an active state, out of the plurality of operation states; and
a drive control section provided in between the signal transformation section and the drive section so as to prohibit the drive section from driving the control target device for a duration while at least two individual signal lines out of the plurality of individual signal lines are in the active state.

2. The operation control system according to claim 1, wherein:
each of the individual signal lines includes an input signal line arranged in between the signal transformation section and the drive control section, and an output signal line arranged in between the drive control section and the drive section;
the drive control section is connected with the signal transformation section via a plurality of input signal lines, the drive control section including a plurality of logic circuits connected to the drive section via a plurality of output signal lines, respectively;
out of the plurality of output signal lines, an output signal line connected with one of the plurality of logic circuits is defined as a target output signal line relative to the one of the plurality of logic circuits;
out of the plurality of input signal lines, an input signal constituting one of the individual signal line along with the target output signal line is defined as a target input signal line relative to the one of the plurality of logic circuits while any other input signal line of the plurality of input signal lines excluding the target input signal is defined as a non-target input signal line relative to the one of the plurality of logic circuits; and
the drive control section causes the target output signal line to become in the active state only when the target input signal line is in the active state and, simultaneously, the non-target input signal line is in an inactive state.

3. The operation control system according to claim 1, wherein:
the control target device is a wiper provided in a vehicle; and
the plurality of operating states include a plurality of operation speeds of the wiper.

4. The operation control system according to claim 1, wherein:
the control target device is a pair of a left turn lamp and a right turn lamp that are arranged symmetrically in a left-right direction in a vehicle; and
the plurality of operation states include (i) a state where one of the left turn lamp and the right turn lamp is blinked and (ii) a state where an other of the left turn lamp and the right turn lamp is blinked.

5. The operation control system according to claim 2, wherein:
the control target device is a wiper provided in a vehicle; and
the plurality of operating states include a plurality of operation speeds of the wiper.

6. The operation control system according to claim 2, wherein:
the control target device is a pair of a left turn lamp and a right turn lamp that are arranged symmetrically in a left-right direction in a vehicle; and
the plurality of operation states include (i) a state where one of the left turn lamp and the right turn lamp is blinked and (ii) a state where an other of the left turn lamp and the right turn lamp is blinked.
